(19) United States
(12) Patent Application Publication
(10) Pub. No.: US 2006/0284784 A1
(43) Pub. Date: Dec. 21, 2006

(54) UNIVERSAL ANTENNA HOUSING

(76) Inventors: Norman Smith, Santa Rosa, CA (US); Thorsten W. Hertel, Austin, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/424,442

(22) Filed: Jun. 15, 2006

Related U.S. Application Data
(60) Provisional application No. 60/691,789, filed on Jun. 17, 2005.

(51) Int. Cl. H01Q 1/44; H01Q 1/42

(52) U.S. Cl. 343/872; 343/856

(57) ABSTRACT

A universal antenna housing suited for deployment under the glass dome of a utility meter. The housing is fitted with an integrated antenna for wireless radio communications. Applications include the transmission and receiving of radio communication for wireless automatic meter reading (AMR) systems, as well as commercial, industrial or residential utility meters that operate at a plurality of unlicensed or licensed radio frequencies. A configuration and method for economical assembly of an antenna is also disclosed.

### RELATED APPLICATION

This application claims benefit of U.S. Provisional Application Ser. No. 60/691,789, filed Jun. 17, 2005, which is hereby fully incorporated herein by reference.

### FIELD OF THE INVENTION

The field of the invention relates generally to antennas. Specifically, the invention relates to a low profile housing for containment of antennas.

### BACKGROUND OF THE INVENTION

Over the years, utility providers have evolved toward so-called automated meter reading (AMR) systems for the collection of utility data. See, e.g., U.S. Pat. No. 5,298,894 (discussing a remote meter reading arrangement wherein data is collected by a hand held or mobile data collection units) and U.S. Pat. No. 6,653,945 (discussing a radio communications network that transmits data to a central station via fixed point relay stations).

A vital component in AMR systems is the antenna that receives and transmits the local meter information. Newer utility meters feature electronic signal generation that is readily digitized for AMR transmission. Retrofit kits have also been developed that generate electronic data within existing conventional meters. Some AMR-compatible meters require antennas that are externally mounted.

Other AMR devices, such as that disclosed in U.S. Pat. No. 6,181,294, feature small antennas that mount within the meter itself, transmitting and receiving radio signals through a dielectric portion of the meter housing. The configuration of these antennas is such that they must occupy a certain footprint within the meter, and are thus precluded from deployment in many retrofits. Also, these antennas cannot typically be oriented to optimize the signal received by remote collection devices.

The need exists for a low profile antenna assembly that can be incorporated into new and existing utility meters and can be physically oriented for optimum transmission and reception.

### SUMMARY OF THE INVENTION

Various embodiments of the invention disclosed herein provide a universal housing for a wide variety of low profile antenna assemblies. The housing and assembly occupy a minimal footprint within the dielectric housing of a utility meter, and is particularly suited for mounting under glass domes common to electric utility meters. The assembly can be oriented to optimize signal transmission and reception to and from a remote location, and is compatible with a variety of antenna arrangements. Antennas and balanced-to-unbalanced transformers (BALUN) that are compatible with the universal housing are also disclosed.

In one configuration of the invention, a lunate housing receives a flexible dipole antenna within a recess on the lunate housing. The lunate housing may be disposed in the annular region between a metering device and a dielectric dome that surrounds the metering device. The recess in the antenna housing enables the antenna to be located in close proximity to the internal components of the meter without significant degradation of performance.

The housing may be mounted to a surface within the meter with posts or set screws that pass through the antenna housing and onto or through the mounting surface. Alternatively, the housing may be configured to resiliently clamp itself to internal meter structures, thereby securing the antenna in a fixed orientation.

The antenna embodiments disclosed have printed circuit patterns with feed points in close proximity to each other near the center of the pattern. The close proximity enables coaxial cables or printed circuit strips to be attached to the feed points in a straight alignment, without need for bending or otherwise routing the leads to contact the feed points.

### BRIEF DESCRIPTION OF THE DRAWINGS

FIG. 1 is an isometric view of an embodiment of the invention.

FIG. 2 presents a layout and a connection scheme for a printed circuit antenna in an embodiment of the invention.

FIG. 3 depicts a layout and a connection scheme for a printed circuit antenna in an embodiment of the invention.

FIG. 4 shows an exploded view of an application in a utility meter according to an embodiment of the invention.

FIG. 5 depicts an assembly of the FIG. 4 embodiment of the invention.

FIG. 6 illustrates lateral axes of symmetry for a variety of cross-sections.

### DETAILED DESCRIPTION OF THE EMBODIMENTS

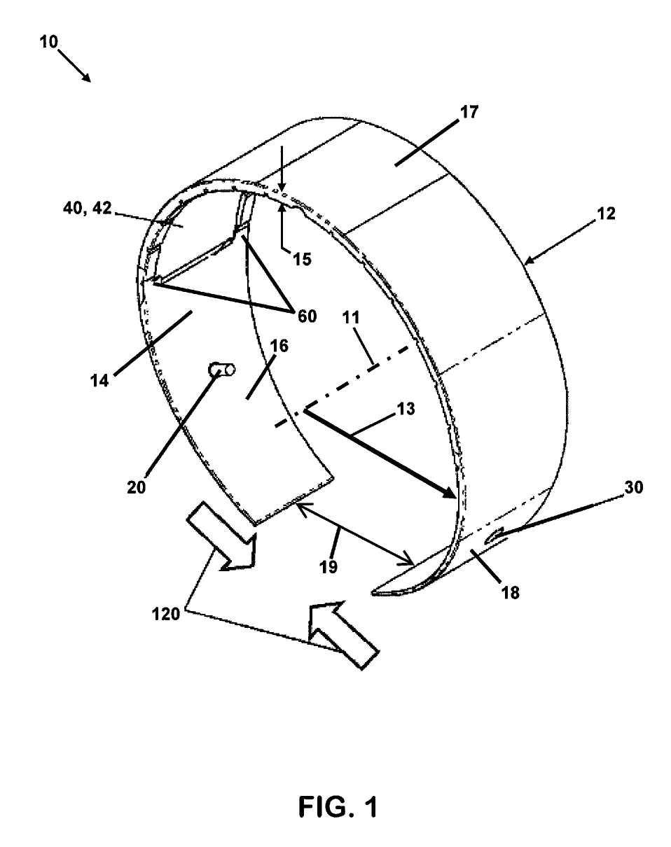

Referring to FIG. 1, an embodiment of the universal antenna housing 10 is shown in isometric projection. The antenna housing 10 may be formed from an injection molded single piece resilient strip 12 of lunate shape having an inner radius 13 about a central axis 11, an inner face 14, end portions 16 and 18, and a mid portion 17. A gap 19 separates the free ends of the end portions 16, 18. The housing 10 may be manufactured from ABS plastic or a similarly resilient material.

The universal antenna housing 10 may utilize a mounting scheme that is similar in concept to a plastic head-band or bicycle clip. Here, the concept is adapted for this novel application and used here for housing and mounting of an antenna for a so-called “under glass mounted” electric utility meter in an Automated Meter Reading (AMR) communications network. The invention may also be applied in other fixed, drive by, mobile or mesh network applications, other than the electricity utility meters, such as for water and gas utility reading. While much of the discussion herein is directed to the housing of flexible antennas, it is noted that the invention is equally applicable to many non-flexible antennas.

A first alignment post 20 may depend from the end portion 16, and a second alignment post 30 may depend from the other end portion 18. In one embodiment, the first alignment post 20 has a smaller diameter than the second alignment post 30. The alignment posts 20, 30 may be oriented to protrude radially inward, and may be of a constant cross-section (e.g. a cylinder) or of varying cross-section (e.g. a frustum). In one embodiment, the alignment posts 20, 30 are formed integrally with the single strip resilient strip 12, but are frangibly connected to the strip 12 to allow the posts 20, 30 to be easily removed. In another embodiment, a mark (not depicted) such as an “X” or a center punch is formed on the back end of the posts 20, 30 so that a user can readily drill out the posts 20, 30. Either way, a hole (not depicted) results which can be used as a guide for forming a hole on the surface of the object to which the housing is to be mounted.

In one embodiment, an elongated recess 40 having an interior face 42 is formed on the inner face 14. A plurality of tab portions 60 extending over at least a portion of the recess 40 and are flush with the inner face 14. The tab portions 60 may be located proximate to each corner of the elongated recess 40. Tabs may also extend from the perimeter of the recess 40 away from the corners.

The embodiment of FIG. 1 portrays a housing 10 having a truly lunate profile, i.e. having a thickness 15 that is greater along the mid portion 17 than on the end portions 16 and 18 to accommodate the depth of the recess 40. However, one may utilize a c-shaped profile of substantially uniform thickness, or even of reduced thickness in the mid portion 17 relative to the end portions 16 and 18 for selective flexibility of the housing 10. Other profiles are also possible without departing from the spirit of the invention, such as continuous ring, rectangular, partial rectangular or U-shaped profile.

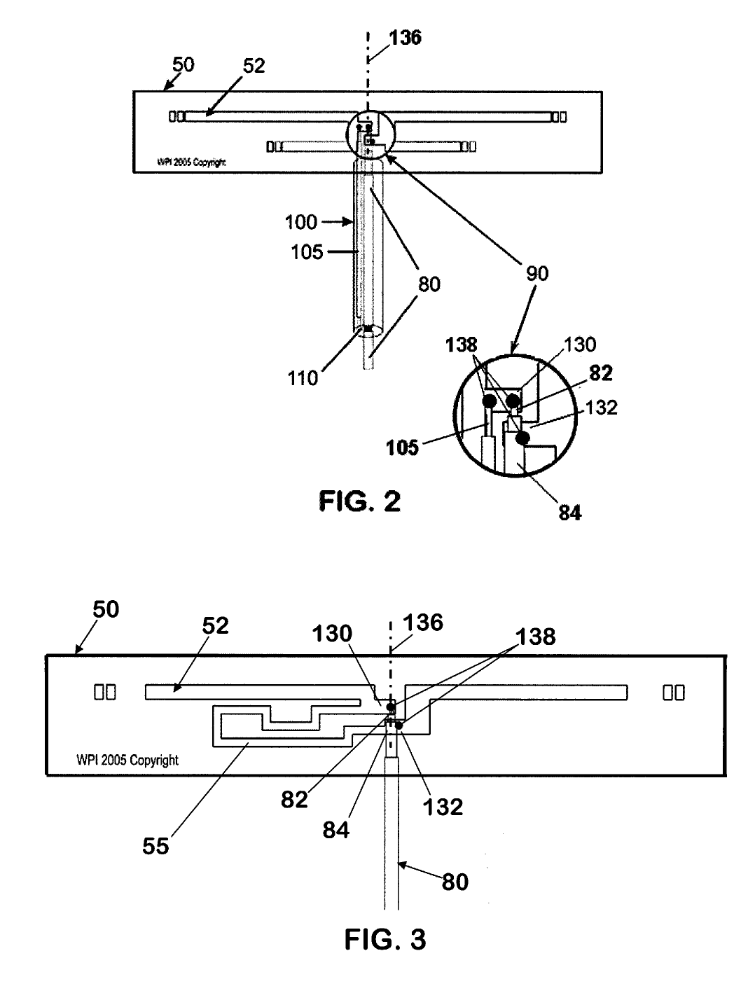

Referring to FIG. 2, a printed circuit antenna 50 according to an embodiment of the invention is shown. The antenna 50 fits within the recess 40 of FIG. 1 and is captured at the corners by the tab portions 60. The antenna 50 may be constructed of a woven fiberglass such as FR4, or of a similar flexible circuit board material suitable for use at the operating frequencies. Other flexible antennas, such as a stamped metal antenna, are candidate antennas for mounting in the housing 10. Also, antenna configurations other than dipole (e.g. monopoles and planar inverted F antennas) may be accommodated by the housing 10. The printed circuit antenna 50 may be sufficiently flexible to enable bending by hand between the forefinger and thumb and inserted into the recess 40 and underneath the tab portions 60. After mounting, the printed circuit antenna 50 registers flush against the interior face 42 of the recess 40. In this way, the housing 10 provides a standoff or otherwise suspends the antenna 50, thereby preventing unwanted contact with external devices that can hinder antenna performance.

The antenna 50 in the FIG. 2 embodiment has a printed dipole pattern 52 and is connected to a radio modem (not shown) via a length of cable 80. The cable 80 is a coaxial cable comprising a center conductor 82 and a ground shielding 84. The coaxial cable 80 is attached to an antenna feed point 90 at one end and may be terminated with a coaxial connector such as a SMA, MMCX or other commercially available connector. Cables and connector types other than coaxial may also be utilized 0002E

For the efficient electrical operation of the antenna 50, a balanced to unbalanced transformer (BALUN) 100 comprising a quarter wavelength solid core wire 105 may be connected between the antenna feed point 90 and the ground shielding 84 of the coaxial cable 80 at a distal location 110 displaced by the feed point 90 by roughly a quarter wavelength. The BALUN 100 converts the balanced dipole impedance to the unbalanced line impedance of the coaxial cable 80, thereby significantly reducing ground currents that may degrade antenna efficiency and radiation performance.

The layout of the printed circuit antenna 50 shown in FIG. 2 includes a pair of pads 130 and 132 at the feed point 90 that that lie along an axis 136. The pads 130 and 132 facilitate a pre-trimmed and cut coaxial cable 80 for easy application of solder points 138 without bending the coaxial cable 80 to bridge between the two feed points of the printed dipole pattern 52. This method of attachment has proven cost effective in mass production, avoiding the need for adhesive or other mechanical means of anchoring the coaxial cable 80 to the antenna 50. The pads 130 and 132 can be used in a variety of printed antenna frequency designs including unbalanced and planar inverted F antennas, and is especially useful for dipole type configurations.

Referring to FIG. 3, a different embodiment of a dipole antenna printed on flexible substrate is depicted. Like the FIG. 2 embodiment, the center conductor 82 and the ground shield 84 of the coaxial line 80 are in electrical contact with the pads 130 and 132, respectively. However, the printed dipole pattern 52 includes a printed quarter-wavelength structure 55 between pads 130 and 132. The quarter-wavelength structure 55 thus serves as integrated BALUN and, akin to the BALUN of FIG. 2, reduces cable currents that may degrade the antenna performance. Because there is no need to connect an external BALUN, the number of solder points 138 in the assembly process as well as the number of components to be handled in the assembly process is reduced, further increasing assembly line productivity.

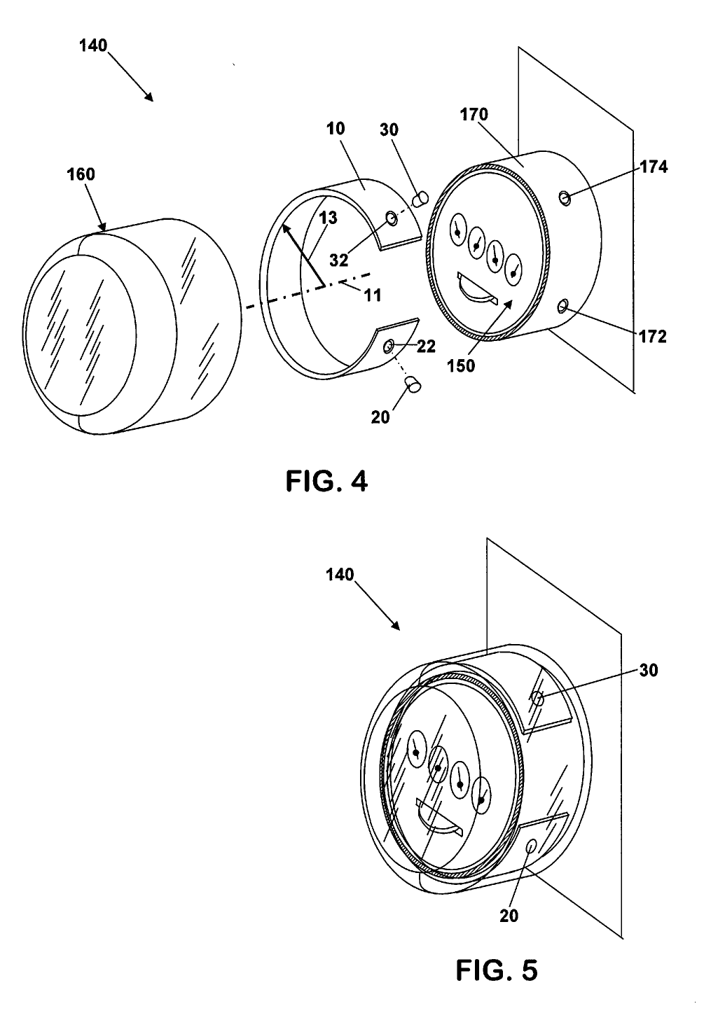

Referring to FIGS. 4 and 5, the housing 10 and antenna assembly is depicted “under glass mounted” in an electric utility meter assembly 140 in exploded and assembled view, respectively. The exploded view of FIG. 4 shows alignment posts 20 and 30 as being removed from the single piece resilient strip 12 to reveal openings 22 and 32. The utility meter assembly 140 may include a panel mounted metering device 150. A dielectric dome 160 is typically made of glass or polycarbonate, but may be made of any other suitably rugged dielectric material.

Traditionally, the dome 160 is made from a transparent material, or has a transparent component that allows viewing of the face of the metering device 150. The utility meter assembly 140 also includes a mounting surface 170 that surrounds the perimeter of the metering device 150. It is noted that a mounting surface that completely surrounds the metering device 150 is not necessary; many meters have mounting surfaces that occupy only a portion of the perimeter of the metering device 150, and can still utilize embodiments of the invention.

In one embodiment of the invention, it is desirable to mount the antenna housing 10 so that the gap 19 is on the right or left side as one faces the metering device 150. The resulting antenna radiation pattern is vertically polarized so that maximum antenna gain is achieved in a horizontal direction, thereby optimizing the signals transmitted to a remote receiver. Likewise, the antenna housing 10 could be oriented for polarization in the horizontal plane for maximum antenna gain in the vertical direction, or oriented for maximum gain in an arbitrary plane between horizontal and vertical.

The use of alignment posts 20, 30 of different diameter helps avoid improper orientation of the antenna housing 10. In one embodiment of the invention, the objective device 170 is formed or pre-drilled with mounting holes 172, 174 that correspond to the differing diameters of the alignment posts 20 and 30, respectively. The differing diameters of the posts 20 and 30 effectively keys the installation of the housing 10 and prevents misalignment of the antenna polarization pattern to ensure repeatable and consistent antenna electrical radiation patterns and fields of electrical polarization for between installations.

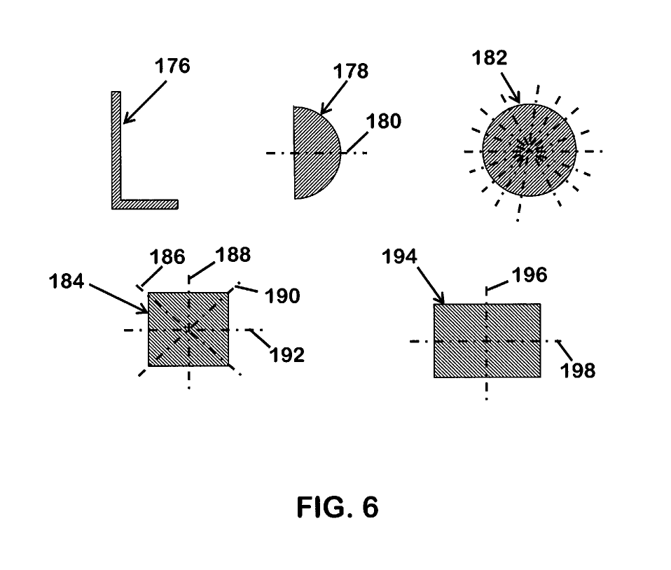

Alternatively, a single alignment post having a cross-section with at most one lateral axis of symmetry and cooperating with an appropriately formed mating receptacle may serve to key the antenna housing 10 in a particular orientation upon mounting. (Herein, a “lateral axis” refers to an axis that is on the plane of the cross-section of the post.) Referring to FIG. 6, a post having an L-shaped cross-section 176 (i.e. a first leg longer than a second leg) has no lateral axis of symmetry. Accordingly, a mating hole that conforms to the L-shaped cross-section 176 enables mounting of the antenna in only one orientation. Likewise, a post having a semi-circular cross-section 178 has only one lateral axis of symmetry 180, and can also be mounted in only one orientation. In contrast, single mounting posts that have more than one lateral axis of symmetry are not keyed for a single orientation. For example, a single post having a circular cross-section 182 has an infinite number of lateral axes of symmetry, and the post may be mounted in any rotational orientation. A square cross section 184 has four lateral axes of symmetry 186, 188, 190 and 192, thus enabling mounting in four different orientations. A rectangular cross section 194 has two lateral axes of symmetry 196 and 198 and enables two different orientations. Hence, when using a single post, cross sections that are asymmetrical or symmetrical with respect to only one lateral axis enable a mounting orientation thereby providing a specific polarization field.

In another embodiment, there are no pre-formed mounting holes; instead, the openings 22 and 32 in the single piece resilient strip 12 serve as a guide for drilling mounting holes 172 and 174 into the objective device 170 in a field installation. This means of securing the housing 10 allows optimization of the field radiation pattern by allowing the installer to rotate the housing 10 about the perimeter of the metering device 150 until the transmitter gain performance or reception of the carrier signal from the base station is maximized.

In still another embodiment of the invention, the housing 10 does not require mounting posts 20 or 30, or the attendant openings 22 or 32 or the mounting holes 172 or 174. Instead, the c-shaped or lunate configuration of the housing 10 in combination with the resiliency of the strip 12 acts to clamp the housing 10 to the objective device 170. In this embodiment, the housing 10 may be formed with an effective inner radius 13 that is smaller than the effective radius of the objective device 170. A housing 10 that having a radius that is approximately 70-80% of the mounting radius of the objective device 170 is typical.

The reduced inner diameter of the housing 10 provides a restoring force 120 (denoted by arrows in FIG. 1) when the housing 10 is radially expanded to fit over the objective device 170, applying a substantially uniform clamping pressure over portions of the objective device 170. In some cases, this embodiment negates the need for a substantial mounting surface altogether; the housing 10 may instead register directly on the support structure that suspends the metering device 150 from the mounting panel (not depicted).

The above descriptions disclose a lunate or c-shaped housing. A continuous ring geometry may also be utilized. A ring geometry could be fixed in place by set screws that extend radially through the ring to seat on the mounting surface.

The antenna 50 may be designed for operation in any part of the licensed or unlicensed FCC or international radio spectrum (licensed or unlicensed) typically used in AMR Radio Communication Networks. For AMR fixed wireless networks and mesh wireless networks that are presently available and planned, the anticipated operational frequency is in the 902-928 MHz ISM band, the 2.4 GHz ISM band, the GSM 800 MHz band, the CDMA 850 MHz band, the GSM 900 MHz band, the DCS 1800 MHz band, the PCS 1900 MHz band and the UMTS 2.1 GHz, or other privately held license frequency bands such as the 1.409 GHz band. These operating frequency bands are offered as exemplary, and embodiments of the invention are not limited to any specific licensed or unlicensed operational frequency. Certain embodiments of the invention may be configured to operate at one or more FCC approved radio frequencies by exchanging the antenna 50 with one designed for the desired frequencies of operation.

While the above descriptions are directed to electric utility meters, the invention is considered to be universal in nature. The application to water and gas utility meters is readily apparent. Also, because the operating frequency band of the antenna 50 may be tailored to any situation, and the radiation field can be optimized in any direction about the central axis of the housing, the invention has utility outside the AMR applications. Moreover, the low profile design and self-clamping aspects of the housing 10 permits application in a number of circumstances.

All aspects of the embodiments presented and discussed in detail above are exemplary of the invention, and are non-limiting. For example, many of the embodiments described and depicted herein are directed to printed circuit dipole antennas. Such depictions and descriptions are exemplary in nature, and would not preclude the use of antennas that are neither printed circuit nor dipole antennas. Various other modifications and changes with which the invention can be practiced and which are within the scope of the description provided herein will be readily apparent to those of ordinary skill in the art.

What is claimed is:

1. An antenna assembly comprising:
a housing comprising:
a dielectric strip formed about a central axis and having a thickness, a face and an end; and
a recess formed on said face of said dielectric strip; and
an antenna disposed in said recess.

2. The antenna assembly of claim 1 further comprising an antenna mounting surface in said recess, said antenna mounting surface being substantially parallel to said face of said dielectric strip; and wherein said antenna is in contact with said antenna mounting surface.

3. The antenna assembly of claim 2, further comprising a plurality of tabs extending substantially parallel to said face of said dielectric strip, said tabs extending at least partially over said antenna mounting surface, said antenna being captured between said tabs and said antenna mounting surface.

4. The antenna assembly of claim 1 further comprising a single post having a cross-section that cooperates with a mating receptacle on an objective device to key said housing in a specific orientation with respect to said objective device, said cross-section having no more than one lateral axis of symmetry.

5. The antenna assembly of claim 1 further comprising at least one guide hole formed through said thickness of said housing to facilitate mounting of said housing to an objective device.

6. The antenna assembly of claim 1 further comprising a mark that locates where to form a guide hole.

7. The antenna assembly of claim 1 wherein said housing is under glass mounted.

8. The antenna assembly of claim 1 further comprising a utility meter operatively attached to said antenna for automated meter reader wireless communication.

9. The antenna assembly of claim 1 further comprising at least one post to secure said housing to an objective device.

10. The antenna assembly of claim 1, wherein said dielectric strip is formed from a single piece material.

11. The antenna assembly of claim 10, wherein said single piece material is an injection molded material.

12. The antenna assembly of claim 1, wherein said dielectric strip further comprises a portion that defines a radius and having a shape selected from the group consisting of a U-shape, C-shape and lunate, said face of said dielectric strip being normal to said central axis.

13. The antenna assembly of claim 12, wherein said face of said dielectric strip faces inward.

14. The antenna assembly of claim 12, wherein said housing is dimensioned to cooperate with an objective device so that said radius is of greater dimension when mounted on said objective device to exert a restoring force that secures said housing to said objective device.

15. The antenna assembly of claim 12 having at least a first post and a second post, each of said first and second posts depending from said face of said housing and having a base cross-section defined at said face of said housing and wherein said base cross-section of said first post is of a substantially smaller cross-section than said base cross-section of said second post.

16. The antenna assembly of claim 12 wherein said at least one post has a circular cross-section.

17. The antenna assembly of claim 12 wherein said antenna is a flexible antenna.

18. The antenna assembly of claim 17 wherein said flexible antenna is a printed circuit antenna or a stamped metal antenna.

19. A method of mounting an antenna comprising:
selecting an antenna assembly comprising
a housing having a shape about a central axis,
at least one post extending radially inward from said housing, and
an antenna substantially conforming to said shape of said housing;
selecting a mounting surface having a mating receptacle compatible with said at least one post; and
placing said at least one post in said mating receptacle of said mounting surface.

20. A method of fabricating a flexible antenna comprising:
selecting a dielectric substrate having an antenna pattern comprising a first solder pad and a second solder pad, each of said first and second solder pads being located substantially on an axis;
providing a cable comprising a central conductor and a ground shielding, said central conductor protruding substantially linearly from an exposed end of said ground shielding;
aligning said cable substantially parallel with said axis;
placing said central conductor in electrical contact with said first solder pad and attaching said central conductor to said first solder pad; and
placing said exposed end of said ground shielding in electrical contact with said second solder pad and attaching said ground shielding to said second solder pad.
